(19) United States
(12) Patent Application Publication
(10) Pub. No.: US 2026/0270697 A1
(43) Pub. Date: Sep. 10, 2026

(54) SYSTEMS AND METHODS FOR DEACTIVATION OF INACTIVE SUBSCRIPTIONS

(71) Applicant: T-Mobile Innovations LLC, Overland Park, KS (US)

(72) Inventors: Zoltan HOMORODI, North Bend, WA (US); Nilesh RANJAN, Sammamish, WA (US)

(21) Appl. No.: 19/071,009

(22) Filed: Mar. 5, 2025

(51) Int. Cl. H04W 12/06; H04W 8/20; H04W 12/72

(52) U.S. Cl. CPC H04W 12/06; H04W 8/205; H04W 12/72

(57) ABSTRACT

Systems, methods and devices are provided for network congestion management. The method includes receiving, by a wireless network communicatively connected to a wireless device comprising a subscriber identity module (SIM), an authentication request, wherein the authentication request comprises a subscriber identifier, determining, by the wireless network, a subscriber status based on the subscriber identifier, in response to determining the subscriber status, transmit, by the wireless network an over-the-air (OTA) signal to the wireless device and disabling the SIM using the OTA signal.

### TECHNICAL BACKGROUND

Wireless networks, such as 5G and LTE networks, often support subscriber identity module (SIM) authentication. A wireless network may verify a subscriber's identity using a subscriber identifier stored on a removable SIM installed in the user device or an integrated SIM (eSIM). In instances, wireless networks are capable of sending instructions configuring a user device through over-the-air (OTA) signals once the user device is authenticated and a session is established. For example, a wireless network may be capable of assigning a new subscriber identifier for the associated SIM.

### OVERVIEW

Exemplary embodiments described herein include systems, methods, and processing nodes for deactivating an inactive subscription. An exemplary method includes receiving, by a wireless network communicatively connected to a wireless device comprising a subscriber identity module (SIM), an authentication request, wherein the authentication request comprises a subscriber identifier and determining, by the wireless network, a subscriber status based on the subscriber identifier. The method further includes, in response to determining the subscriber status, transmit, by the wireless network an over-the-air (OTA) signal to the wireless device and disabling the SIM using the OTA signal.

Further exemplary embodiments include a system for deactivation of inactive subscriptions. The system includes a wireless device comprising a subscriber identity module (SIM) and wireless network comprising at least one computing device communicatively connected to the wireless device, wherein the at least one computing device is configured to receive an authentication request from wireless device comprising a subscriber identity module (SIM), wherein the authentication request, determine a subscriber status based on the subscriber identifier, in response to determining the subscriber status, transmit an over-the-air (OTA) signal to the wireless device and disable the SIM using the OTA signal.

In yet a further exemplary embodiment, a non-transitory computer readable medium is provided. The non-transitory computer-readable medium stores instructions, when executed by a processor, configuring the processor to receive an authentication request from a wireless device comprising a subscriber identity module (SIM), wherein the authentication request comprise a subscriber identifier, determine a subscriber status based on the subscriber identifier, in response to determining the subscriber status, transmit an over-the-air (OTA) signal to wireless device and disable the SIM using the OTA signal.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates a times series flow for deactivation of an inactive subscription in accordance with disclosed embodiments;

FIG. 3 illustrates an exemplary process flow for deactivation of an inactive subscription in accordance with aspects of this disclosure;

FIG. 4 illustrates an example of a computing device in accordance with aspects of this disclosure; and

FIG. 5 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a core network, such as a LTE or new radio 5G (NR 5G), provides deactivation of inactive subscriptions based on disabling a SIM.

Wireless networks usually purge, or remove, inactive subscriptions for their records after a set time period. As user that deactivate their accounts may return to the network after a time, wireless networks usually set a purge period for many years for a subscriber identifier. For example, a wireless network may set a purge period for three years from the time a service is disconnected, as in some cases the subscriber may become active again within that period.

In most situations, the subscriber will either stay inactive until the purge or the subscriber may reactivate their account prior to that period. However, in some cases, an inactive subscription may try to attempt to attach to the wireless network. To protect the network from unauthorized access, the wireless network may disable the SIM prior to the purge period for that subscriber.

For an inactive subscription stored in a SIM, a wireless network may transmit a self-executing application to the SIM causing the SIM to disable itself. For SIMs unable to execute the application above, the wireless network may nevertheless disable the SIM by changing the subscriber identifier stored in the SIM to an invalid value, thus rendering the SIM unable to attempt further authentication against the network.

Upon receiving an authentication request, the wireless network determines if the subscription associated with subscriber identifier, included in the request, is inactive. If the subscriber is no longer active, but still valid (i.e. the subscription has not been purged), the wireless network may compare attributes of the request and the subscription to set polices. For example, the wireless network may have a policy to disable the SIM associated with the subscription based on a number of attachment attempts by that subscriber, which may indicate malicious attempts at gaining access to the network.

A wireless network may be able to prevent attachment attempts by inactive subscription prior to a purge period by disabling the SIM associated with that subscriber identifier, even for older SIMs.

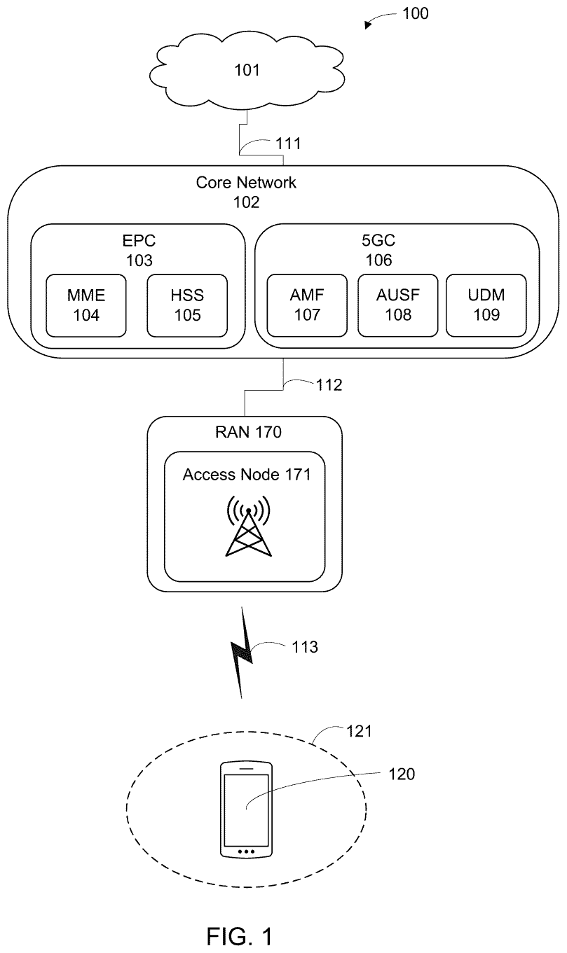

These and other examples will be described in greater detail below in relation to FIGS. 1-5.

FIG. 1 depicts an exemplary system 100 for deactivation of inactive subscription. System 100 includes a communication network 101, a core network 102, a radio access network (RAN) 170 and wireless devices 120.

Core network 102 is connected to communication network 101 over communication link 111. Core network 102 includes an evolved packet core (EPC) 103. EPC 103 as used herein are core network components used for managing data for LTE, 4G, and/or other networks. In embodiments, EPC 103 includes a mobility management entity (MME) 104 and a home subscriber server (HSS) 105. MME 104 is responsible for handling connection and mobility management tasks on an LTE/4G network. HSS 105 is responsible for storing a subscriber's identifier and secret keys, and it further provides authentication vectors. In instances, MME 104 uses authentication vectors generated by HSS 105 to authenticate a user device, such as wireless device 120 described further below. In embodiments, HSS 105 may store an authentication profile associated with wireless device 120, where the authentication profile may include a subscriber identifier.

Core network 102 includes a 5G core (5GC) 106. 5GC 106 as used herein are core network components used for managing data for 5G networks. In embodiments, 5GC 106 includes an access and mobility function (AMF) 107, an authentication server function (AUSF) 108 and unified data management (UDM) 109. AMF 107 receives connection and session related information from a user device and is responsible for handling connection, registration and mobility management tasks on a 5G network. AUSF 108 is responsible for handling authentication requests from a user device. UDM 109 stores subscribers' identifiers, including authentication credentials. In embodiments, AMF 107 receives an authentication request that includes a device identifier, AMF 107 forwards the device identifier to UDM 109. UDM 109 generates an authentication vector using the AUSF 108, where the authentication vector is then used by AMF 107 to authenticate the user device. In instances, AMF 107 transmits OTA instructions to a user device. For example, AMF 107 may transmit an OTA instruction modifying the device identifier for the user device, such as an identifier in a SIM card.

It should be noted that core network 102 may include other components used for managing data for networks not described herein, such as a satellite core network. Furthermore, it should also be noted that in other embodiments, the core network 102 may have other types of core architecture (e.g., 6G core architecture) that at least perform some similar functions as and/or share at least some components with EPC 103 and 5GC 106 with respect to connection and authentication of a user device. For example, embodiments described herein may utilize an AI-enhanced AMF of a 6G network.

The RAN 170 includes access nodes 171. In embodiments, the access nodes 171 include an evolved Node B (eNodeB) and a next generation Node B (gNodeB). As used herein, an eNode B is a base station in LTE/4G networks used for connecting a user device, such as wireless device 120, to core network 102. A gNodeB, as used herein, is a base station in new radio 5G networks and/or other networks used for connecting a user device to core network 102. The gNodeB may include, for example, centralized units (CUs) and distributed units (DUs).

RAN 170 is connected to core network 102 over communication link 112. RAN 170 may include other devices and additional nodes not described herein. For example, RAN 170 may include devices used for forwarding media files over IP from wireless devices 120 to core network 102.

System 100 also includes wireless devices 120. In embodiments, system 100 may include two or more wireless devices. Wireless devices 120 are configured to operate in one or more coverage areas 121. Wireless devices 120 may include an end-user wireless device. Wireless devices 120 may include any device configured to send and receive data. In instances, wireless devices 120 may include an integrated SIM (eSIM). In embodiments, wireless device 120 may include a removable SIM card. In embodiments, wireless device 120 communicates with RAN 170 over communication link 113. Examples of communication link 113 may include 5G network, 4G LTE, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless devices 120. Wireless network protocols can include multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a UDM function, such as UDM 109, an application function (AF), an AMF, such as AMF 107, an AUSF, such as AUSF 108, and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF 107, SMF, and NEF. The UDM may function as a stateful message store, holding information in local memory. The NSSF can be used by AMF 107 to assist with the selection of network slice instances that will serve a particular device. Further, the NEF provides a mechanism for securely exposing services and features of the core network.

In instances, UDM 109 may store subscriber credentials, such as authentication credentials. In instances, UDM may store subscriber identifiers, such as a subscriber permanent identifier (SUPI). In instances, UDM may store secret cryptographic keys associated with a subscriber. For example, the secret keys may be used for temporarily authenticating a connection for wireless device 120. In instances, UDM 109 may further include policy data for wireless device 120. For example, UDM 109 may include subscription details for a subscriber. In instances, AMF 107 may terminate an authentication session with wireless device 120 based on policy data associated with a subscriber identifier for wireless device stored in UDM 109.

Although one core network 102 is shown, multiple core networks 102 may be utilized. Alternatively, the single core network 102 may include a distributed, cloud-native, converged core gateway. Thus, the converged core gateway could connect an EPC 103 to 5GC 106 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access nodes 171. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an eNodeB and others may communicate with a gNodeB.

In additional embodiments, access nodes 171 may comprise two co-located cells, or antenna/transceiver combinations that are mounted on the same structure. Alternatively, access nodes 171 may comprise a short range, low power, small-cell access node such as a microcell access node, a picocell access node, a femtocell access node, and/or a home eNodeB device. As will be further described below, functionality for network node switching may be included within the access nodes 171. Access nodes 171 can be configured to deploy one or more different carriers, utilizing one or more RATs. For example, a gNodeB may support NR. It would be evident to one of ordinary skill in the art, in light of this disclosure, the many other combinations of access nodes and carriers that could be deployed.

The access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with access nodes 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access nodes 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network node switching may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

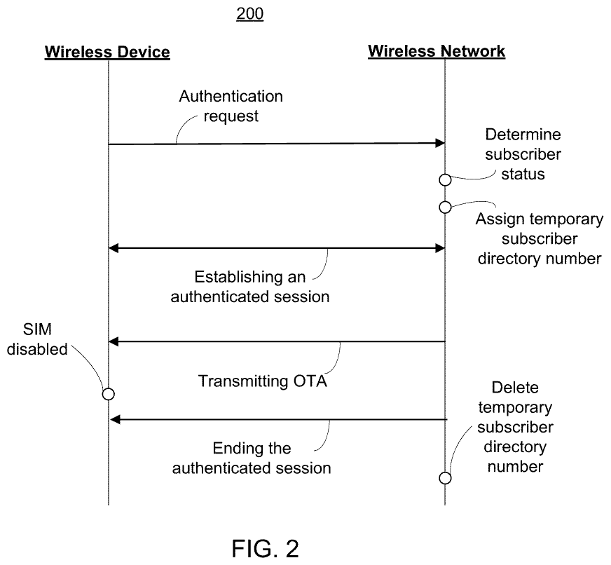

Now referring to FIG. 2, an example time series flow 200 is presented. The time series flow 200 begins with a wireless device, which includes a SIM, transmitting an authentication request to a wireless network. The wireless device may be the same as wireless device 120. The wireless network may include a RAN, core network and/or a communication network, which may be the same as, respectively, RAN 170, core network 102 and communication network 101. The authentication request includes a subscriber identifier. In instances, the subscriber identifier may include an international mobile subscriber identity (IMSI). In embodiments, the subscriber identifier may include a SUPI.

In this time series flow, once the wireless network receives the subscriber identifier, the wireless network determines a subscriber status based on the subscriber identifier. In instances, the wireless network may determine that the subscriber identifier is associated with an inactive subscription. An inactive subscription is a subscription that is no longer active but has not been removed from records of subscriptions of a mobile network operator (MNO). For example, the MNO may remove records of a subscription after three years from the date it was no longer active. In this example, the subscription identifier would still exist in the records of subscriptions, but no longer have access to the wireless network using the MNO.

Based on a determination that the subscription is no longer valid and/or active, the wireless network compares the subscription identifier to a threshold. In instances, the threshold may be a period of inactive time. For example, the wireless network may set a threshold of two years of inactive subscription. In this example, the threshold may be for a shorter time than the automatic removal period. In embodiments, the threshold may also include a number of connection, or authentication, requests from a wireless device associated with an inactive subscription identifier. For example, the threshold may be a total of one hundred authentication requests from the same inactive subscription. In this example, wireless network may deny the authentication requests from the wireless device until the threshold is reached. In instances, determining the subscriber status may include comparing the subscriber identifier to multiple thresholds. For example, the wireless network may compare both the age of the subscription and the number of authentication attempts to set thresholds. In some instances, the wireless network may set a condition of either threshold being met or a condition that all thresholds be met, in which case flow 200 would only continue once all thresholds are met.

Continuing with the time series flow 200, based on determining the subscription status, which includes the request from the wireless device meeting one or more thresholds, the wireless network assigns a temporary subscriber directory number for the wireless device. Using this temporary subscriber directory number, the wireless network establishes an authenticated session with the wireless device. In instances, the temporary subscriber directory number may be a temporary mobile station international subscriber directory number (MSISDN).

Once the session is established, the wireless network transmits an OTA signal that includes instructions configuring the wireless device to modify the subscriber identifier. In embodiments, instructions may configure the wireless device to modify the subscriber identifier to an invalid or null value. In an example, for an IMSI subscriber identifier, the entire IMSI field may be set to 0XF values, thus indicating that the IMSI is invalid. Once the subscriber identifier is invalidated, the SIM storing the subscriber identifier is disabled, thus unable to generate further authentication requests.

In embodiments, once the SIM storing the subscriber identifier is disabled, the wireless network ends the authenticated session and deletes the temporary subscriber directory number from its records.

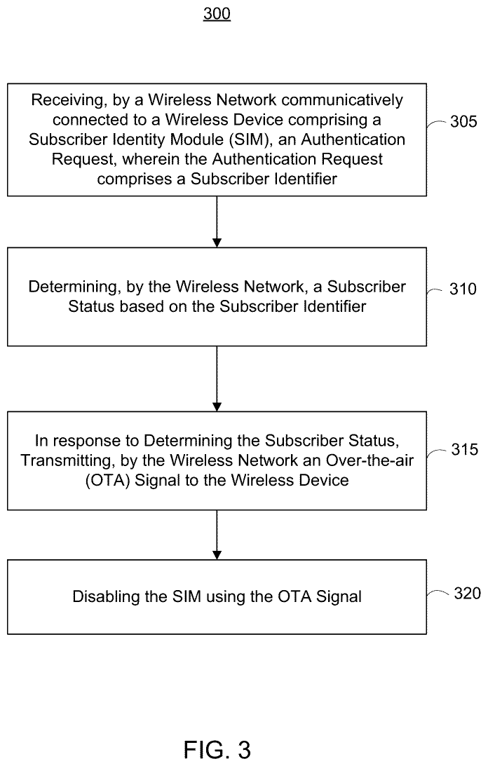

With reference to FIG. 3, a flow diagram of method 300 for deactivation of inactive subscription is presented. Method 300 includes, at step 305, receiving, by a wireless network communicatively connected to a wireless device including a SIM, an authentication request, wherein the authentication request comprises a subscriber identifier. In instances, the subscriber identifier may be an IMSI. In embodiments, the subscriber identifier may be a SUPI. The wireless network may include RAN 170, core network 102 and communication network 101, and the wireless device may be the same as wireless device 120 described in reference to FIG. 2.

In embodiments, method 300 may further include assigning a temporary subscriber directory number to the wireless device and initiating an authentication session for the authentication request based on the subscriber identifier and the temporary subscriber directory number. In embodiments, the temporary subscriber directory number may be a temporary MSISDN.

At step 310, method 300 includes determining, by the wireless network, a subscriber status based on the subscriber identifier. In instances, determining the subscriber status may include comparing a disconnected period value associated with the SIM to a threshold value. In embodiments, determining the subscriber status may include comparing a total number of authentication requests associated with the SIM to a threshold value.

The method 300 includes, at step 315, in response to determining the subscriber status, transmitting, by the wireless network, an OTA signal to the wireless device.

At step 320, method 300 includes disabling the SIM using the OTA signal. In embodiments, disabling the SIM may include modifying the subscriber identifier associated with the SIM to a null or invalid value. For example, the OTA signal may include instructions configuring the wireless device to set the value of the subscriber identifier to a null value, such as setting all field values of an IMSI to an “F” value. In embodiments, method 300 may further include ending the authentication session after modifying the subscriber identifier.

In some embodiments, methods 300 may include additional steps or operations. Furthermore, the methods may include steps shown in each of the other methods. As one of ordinary skill in the art would understand, method 300 may be integrated in any useful manner and the steps may be performed in any useful sequence.

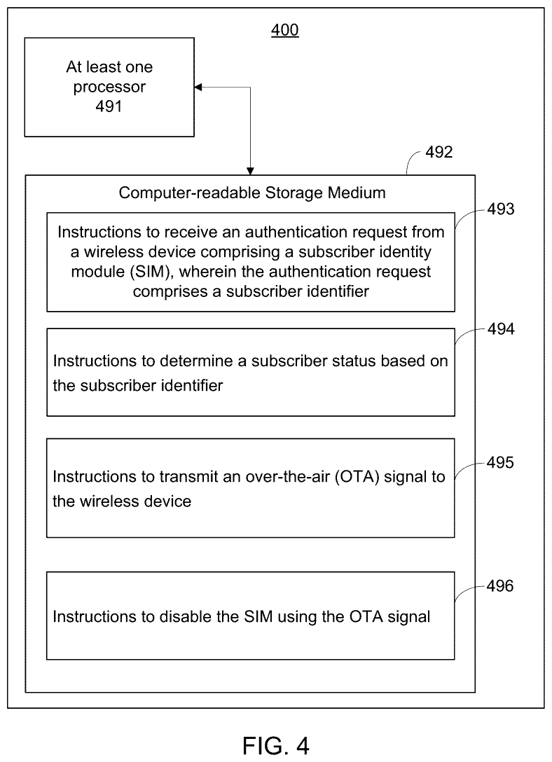

Now referring to FIG. 4, an example computing device 400 is presented. In embodiments, computing device 400 may include a node device, such as devices operating within communication network described in reference to FIG. 1. In this example, computing device 400 includes at least one processor 491 communicably coupled to a computer-readable storage medium 492. The at least one processor 491 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 492. In instances, at least one processor 491 may include electronic circuitry for performing instructions described in this disclosure.

In instances, computer-readable storage medium 492 may be any medium suitable for storing executable instructions. In examples, without limitation, computer-readable storage medium 492 may include read-only memory (ROM), random-access memory (RAM), erasable electrically programmable ROM (EEPROM), Solid State Drive (SSD), optical disc, and the like. Computer-readable medium storage 492 may be disposed within computing device 400. In embodiments, computer-readable storage medium 492 may be external, and communicably connected, to computing device 400. The instruction stored on computer-readable storage medium may be used to implement method steps described in reference to FIG. 3.

In this example, computer-readable storage medium 492 is encoded with a set of instructions 493, 494, 495 and 496. In embodiments, executable instructions included in each block may be included in different blocks shown and blocks not shown.

Instruction 493, when executed by at least one processor 491, configures the at least one processor 491 to receive an authentication request from a wireless device comprising a SIM, wherein the authentication request comprises a subscriber identifier. In embodiments, the SIM may be a removable SIM card. In instances, the SIM may be an integrated SIM (eSIM).

Instruction 494, when executed by at least one processor 491, configures the at least one processor 491 to determine a subscriber status based on the subscriber identifier.

Instruction 495, when executed by at least one processor 491, configures the at least one processor 491 to transmit an OTA signal to the wireless device in response to determining the subscriber status.

Instruction 495, when executed by at least one processor 491, configures a second processor of the at least one processor 491 to disable the SIM using the OTA signal. For example, the OTA signal may include instructions configuring a wireless device to set a subscriber identifier stored in the SIM to a null value.

In embodiments, computer-readable storage medium 4 may include instructions configuring the at least one processor 491 to assign a temporary subscriber directory number to the wireless device and initiate an authentication session for the authentication request based on the subscriber identifier and the temporary subscriber directory number.

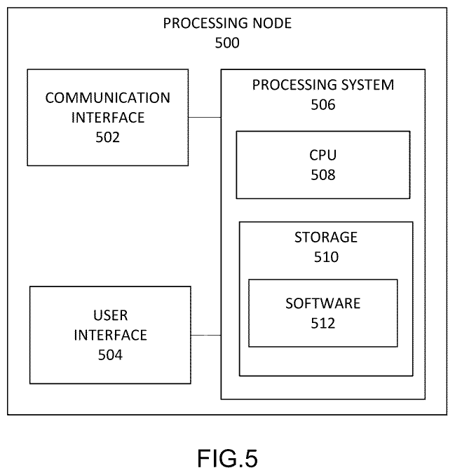

Now referring to FIG. 5, an example processing node 500, which may be configured to perform the methods and operations disclosed herein for network energy reduction. The processing node 500 includes a communication interface 502, user interface 504, and processing system 506 in communication with communication interface 502 and user interface 504. Communication interface 502 may include hardware components, such as network communication ports, devices, routers, wires, antenna, transceivers, etc. User interface 504 may include hardware components, such as touch screens, buttons, displays, speakers, etc.

Processing system 506 includes a central processing unit (CPU) or processor 508 and storage 510. Storage 510 may include a disk drive, flash drive, memory circuitry, or other memory device including, for example, a buffer. Storage 510 can store software 512 which is used in the operation of the processing node 500. Software 512 may include computer programs, firmware, or some other form of machine-readable instructions, including an operating system, utilities, drivers, network interfaces, applications, or some other type of software. Processing system 506 may include a processor 508 and other circuitry to retrieve and execute software 512 from storage 510, which may be internal or external to the processing system 506. Processing node 500 may further include other components such as a power management unit, a control interface unit, etc., which are omitted for clarity. Communication interface 502 permits processing node 500 to communicate with other network elements. User interface 504 permits the configuration and control of the operation of processing node 500. Processing node 500 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 512 may include the instructions described in reference to FIG. 4.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a wireless network communicatively connected to a wireless device comprising a subscriber identity module (SIM), an authentication request, wherein the authentication request comprises a subscriber identifier;
determining, by the wireless network, a subscriber status based on the subscriber identifier;
in response to determining the subscriber status, transmit, by the wireless network an over-the-air (OTA) signal to the wireless device; and
disabling the SIM using the OTA signal.

2. The method of claim 1, further comprising assigning a temporary subscriber directory number to the wireless device; and
initiating an authentication session for the authentication request based on the subscriber identifier and the temporary subscriber directory number.

3. The method of claim 2, wherein disabling the SIM comprises modifying the subscriber identifier associated with the SIM to a null value.

4. The method of claim 3, further comprising ending the authentication session after modifying the subscriber identifier.

5. The method of claim 2, wherein the temporary subscriber directory number is a temporary mobile station international subscriber directory number (MSISDN).

6. The method of claim 1, wherein the subscriber identifier is an international mobile subscriber identity.

7. The method of claim 1, wherein determining the subscriber status comprises comparing a disconnected period value associated with the SIM to a threshold value.

8. The method of claim 1, wherein determining the subscriber status comprises comparing a total number of authentication requests associated with the SIM to a threshold value.

9. The method of claim 1, wherein the SIM is a removable SIM card.

10. The method of claim 1, wherein the SIM is an integrated SIM (eSIM).

11. A system, the system comprising:
a wireless device comprising a subscriber identity module (SIM); and
a wireless network comprising at least one computing device communicatively connected to the wireless device, wherein the at least one computing device is configured to:
receive an authentication request from the wireless device comprising a subscriber identity module (SIM), wherein the authentication request comprises a subscriber identifier;
determine a subscriber status based on the subscriber identifier;
in response to determining the subscriber status, transmit an over-the-air (OTA) signal to the wireless device; and
disable the SIM using the OTA signal.

12. The system of claim 11, wherein the wireless network is further configured to assign a temporary subscriber directory number to the wireless device; and
initiate an authentication session for the authentication request based on the subscriber identifier and the temporary subscriber directory number.

13. The system of claim 12, wherein the wireless network is further configured to modify the subscriber identifier associated with the SIM to a null value.

14. The system of claim 12, wherein the wireless network is further configured to end an authenticated session based on modifying the subscriber identifier.

15. The system of claim 11, wherein determining the subscriber status comprises comparing a disconnected period value associated with the SIM to a threshold value.

16. The system of claim 11, wherein determining the subscriber status comprises comparing a total number of authentication requests associated with the SIM to a threshold value.

17. The system of claim 11, wherein the SIM is one of a removable SIM card or an integrated SIM (eSIM).

18. A non-transitory computer-readable medium storing instructions, when executed by at least one processor, configuring the at least one processor to:
receive an authentication request from a wireless device comprising a subscriber identity module (SIM), wherein the authentication request comprises a subscriber identifier;
determine a subscriber status based on the subscriber identifier;
in response to determining the subscriber status, transmit an over-the-air (OTA) signal to the wireless device; and
disable the SIM using the OTA signal.

19. The non-transitory computer-readable medium storing instructions of claim 18, wherein the at least one processor is further configured to assign a temporary subscriber directory number to the wireless device; and
initiate an authentication session for the authentication request based on the subscriber identifier and the temporary subscriber directory number.

20. The non-transitory computer-readable medium storing instructions of claim 18, wherein the SIM is a removable SIM card or an integrated SIM (eSIM).
